(19) United States
(12) Patent Application Publication
(10) Pub. No.: US 2026/0371028 A1
(43) Pub. Date: Nov. 19, 2026

(54) ELECTRONIC DEVICE AND METHOD OF CONTROLLING SAME

(71) Applicant: SAMSUNG ELECTRONICS CO., LTD., Suwon-si (KR)

(72) Inventors: Inwoo HWANG, Suwon-si (KR); Kibeom KIM, Suwon-si (KR); Sunmin KIM, Suwon-si (KR); Hanki KIM, Suwon-si (KR); Yoonjae LEE, Suwon-si (KR)

(73) Assignee: SAMSUNG ELECTRONICS CO., LTD., Suwon-si (KR)

(21) Appl. No.: 19/726,039

(22) Filed: Jun. 30, 2026

Related U.S. Application Data
(63) Continuation of application No. PCT/KR2024/020052, filed on Dec. 9, 2024.

(30) Foreign Application Priority Data
Jan. 19, 2024 (KR) 10-2024-0009075

(51) Int. Cl. H04S 7/00; G06F 3/01; G06F 3/16

(52) U.S. Cl. CPC H04S 7/303; G06F 3/012; G06F 3/16; H04S 2400/11; H04S 2420/01

(57) ABSTRACT

An electronic device and method of controlling the same for outputting binaural audio are provided. The electronic device recognizes a target sound image location based on detection information about a motion of a head, determines some of a plurality of reference sound image locations stored in a memory as a plurality of indexes based on the recognized target sound image location, obtains reference transfer functions and initial delays corresponding to the determined plurality of indexes determined based on the information stored in the memory, obtains a weight for each index based on the determined plurality of indexes, create a target transfer function based on the obtained weight for each index, the obtained reference transfer functions and the obtained initial delays, create a sound image based on an input source received from an external device and the created target transfer function, and controls an output of the created sound image.

### CROSS-REFERENCE TO RELATED APPLICATIONS

This application is a continuation of International Application No. PCT/KR2024/020052, filed on Dec. 9, 2024, which is based on and claims priority to Korean Patent Application No. 10-2024-0009075, filed on Jan. 19, 2024, in the Korean Ministry of Intellectual Property, the disclosures of which are incorporated by reference herein in their entireties.

### BACKGROUND

### 1. Field

The disclosure relates to an electronic device and method of controlling the same, which creates a sound image through head tracking and outputs the sound image.

### 2. Description of Related Art

Various electronic devices are now being developed with the advancement of IT technologies. Most of the electronic devices provide audio outputs.

The electronic device uses a binaural rendering technology to provide immersive and interactive audio.

The binaural rendering is modeling 3D audio that provides realistic sound in 3D space into a two-channel audio output signal.

Like this, when 3D audio can be modeled into the form of an audio signal to be transmitted into a person's ears, a stereoscopic effect of 2D audio may be reproduced even through the two-channel audio output without many speakers.

In this case, when the number of objects or channels included in the audio signal to be subject to the binaural rendering increases, the computation amount and power consumption required for the binaural rendering may increase. Hence, a technology for efficiently performing binaural rendering on an input audio signal is required for the electronic device having the constraints of computation amount and power consumption.

Furthermore, due to a limited memory volume, data of a head related transfer function (HRTF) may be limited in number. The HRTF is a function summarized by generating the same sound from all directions and measuring a frequency response for each direction.

This may cause deterioration of sound localization performance of the electronic device. Accordingly, there is a need for technologies that may increase the spatial resolution of the audio signal reproduced in the 3D space even with the limited memory volume.

### SUMMARY

The disclosure provides an electronic device and method of controlling the same, which creates a transfer function corresponding to a target sound image location based on the target sound image location, a plurality of reference sound image locations, a plurality of transfer functions stored in advance and a plurality of initial delays stored in advance, and creates a sound image based on the created transfer function.

According to the disclosure, an electronic device includes a memory storing information about a plurality of reference sound image locations, a plurality of reference transfer functions corresponding to the plurality of reference sound image locations, respectively, and initial delays; a communicator configured to receive detection information about a motion of a head; and a processor configured to recognize a target sound image location based on the detection information about the motion of the head received by the communicator, determine some of the plurality of reference sound image locations as a plurality of indexes based on the recognized target sound image location, obtain initial delays and reference transfer functions corresponding to the determined plurality of indexes based on the information stored in the memory, obtain a weight for each index based on the determined plurality of indexes, and create a target transfer function based on the obtained weight for each index, the obtained reference transfer functions and the obtained initial delays.

The plurality of indexes of the electronic device may include a first index and a second index. The obtained reference transfer functions may include a first reference transfer function corresponding to the first index and a second reference transfer function corresponding to the second index.

The processor of the electronic device may be configured to obtain a first weight for the first index and a second weight for the second index based on the first and second indexes, may be configured to obtain a magnitude based on the first reference transfer function, the second reference transfer function and the first and second weights, and may be configured to create an interpolation transfer function based on one of the first and second reference transfer functions and the obtained magnitude.

The processor of the electronic device may be configured to identify a larger weight among the first and second weights, may be configured to obtain an index corresponding to the identified weight, and may be configured to obtain a phase of one of the first and second reference transfer functions, which corresponds to the obtained index as a phase of a reference transfer function for creating the interpolation transfer function.

The processor of the electronic device may be configured to create the interpolation transfer function based on the magnitude and the phase of the reference transfer function corresponding to the obtained index among the first and second reference transfer functions.

The obtained initial delays of the electronic device may include a first initial delay corresponding to the first index and a second initial delay corresponding to the second index.

The processor of the electronic device may be configured to obtain an adjusted delay based on the first and second weights and the first and second initial delays, and may be configured to create a target transfer function based on the obtained adjusted delay and the created interpolation transfer function.

The processor of the electronic device may be configured to obtain a coordinate value of the recognized target sound image location and a coordinate value of each of the plurality of reference sound image locations, may be configured to obtain a distance between the obtained coordinate value of the recognized target sound image location and the coordinate value of each of the plurality of reference sound image locations, and may be configured to obtain a weight for each index based on the obtained each distance.

The electronic device may further include a speaker. The communicator of the electronic device may be configured to communicate with an external device. The processor of the electronic device may be configured to create a sound image based on an input source received from the external device and the created target transfer function, and may be configured to control the speaker to output the created sound image through the speaker.

The electronic device may further include a sensing device for detecting a motion of a head and transmitting the detected detection information to the processor through the communicator.

The communicator of the electronic device may be configured to communicate with an external device and an audio output device. The processor of the electronic device may be configured to create a sound image based on an input source received from the external device and the created target transfer function, and transmit the created sound image to the audio output device.

The target sound image location of the electronic device may include a target azimuth angle and a target elevation angle. Each of the plurality of reference sound image locations of the electronic device may include a reference azimuth angle and a reference elevation angle.

The processor of the electronic device may be configured to determine a preset number of reference azimuth angles in a sequence of having a smaller difference in azimuth from the target azimuth angle among the plurality of reference azimuth angles, may be configured to determine a preset number of reference elevation angles in a sequence of having a smaller difference in elevation from the target elevation angle among the plurality of reference elevation angles, and may be configured to determine a plurality of indexes based on the determined preset number of reference azimuth angles and the determined preset number of reference elevation angles.

The processor of the electronic device may be configured to create a sound image based on a reference transfer function corresponding to a reference sound image location equal to the target sound image location based on the presence of the reference sound image location equal to the target sound image location among the plurality of reference sound image locations.

According to another aspect, a method of controlling an electronic device includes recognizing a target sound image location based on detection information about a motion of a head, determining some of a plurality of reference sound image locations stored in a memory as a plurality of indexes based on the recognized target sound image location, obtaining initial delays and reference transfer functions corresponding to the determined plurality of indexes determined based on the information stored in the memory, obtaining a weight for each index based on the determined plurality of indexes, creating a target transfer function based on the obtained weight for each index, the obtained reference transfer functions and the obtained initial delays, creating a sound image based on an input source received from an external device and the created target transfer function, and controlling output of the created sound image.

The plurality of indexes may include a first index and a second index. The obtained reference transfer functions may include a first reference transfer function corresponding to the first index and a second reference transfer function corresponding to the second index. Creating of an interpolation transfer function may include obtaining a first weight for the first index and a second weight for the second index based on the first and second indexes, may include obtaining a magnitude based on the first reference transfer function, the second reference transfer function and the first and second weights, and may include creating the interpolation transfer function based on a phase of one of the first and second reference transfer functions and the obtained magnitude.

The method of controlling the electronic device may further include identifying a larger weight among the first and second weights, obtaining an index corresponding to the identified weight, and/or obtaining a phase of a reference transfer function corresponding to the obtained index among the first and second reference transfer functions as a reference phase of the interpolation transfer function.

The creating of the interpolation transfer function may include creating the interpolation transfer function based on the magnitude and the phase of the reference transfer function corresponding to the obtained index among the first and second reference transfer functions.

The obtained initial delays may include a first initial delay corresponding to the first index and a second initial delay corresponding to the second index. The creating of the target transfer function may include obtaining an adjusted delay based on the first and second weights and the first and second initial delays, and may include creating a target transfer function based on the obtained adjusted delay and the created interpolation transfer function.

The obtaining of the weight for each index may include obtaining a coordinate value of the recognized target sound image location and a coordinate value of each of the plurality of reference sound image locations, may include obtaining a distance between the obtained coordinate value of the recognized target sound image location and the coordinate value of each of the plurality of reference sound image locations, and may include obtaining a weight for each index based on the obtained each distance.

The target sound image location may include a target azimuth angle and a target elevation angle. Each of the plurality of reference sound image locations may include a reference azimuth angle and a reference elevation angle. The determining of the plurality of indexes may include determining a preset number of reference azimuth angles in a sequence of having a smaller difference in azimuth from the target azimuth angle among the plurality of reference azimuth angles, may include determining a preset number of reference elevation angles in a sequence of having a smaller difference in elevation from the target elevation angle among the plurality of reference elevation angles, and may include determining a plurality of indexes based on the determined preset number of reference azimuth angles and the determined preset number of reference elevation angles.

The method of controlling the electronic device may further include creating a target transfer function based on a reference sound image location equal to the target sound image location not being present among the plurality of reference sound image locations.

The disclosure may reduce timbre distortion while maintaining sound localization performance of an input source.

The disclosure may output a sound image corresponding to a target sound image location of the user even when there are few pieces of reference information for binaural rendering (reference sound image location information, reference transfer function information and initial delay information).

The disclosure may reduce an amount of information stored in a memory of an electronic device, thereby minimizing the volume of the memory.

The disclosure may improve marketability of an electronic device for outputting audio and gain a competitive advantage of the electronic device.

### BRIEF DESCRIPTION OF THE DRAWINGS

FIG. 1 is a block diagram of an audio system including an electronic device, according to an embodiment.

FIG. 2 is a control block diagram of an electronic device, according to an embodiment.

FIGS. 3 and 4 illustrate how to recognize a head position of a user of an audio device, according to an embodiment.

FIG. 5 is a detailed block diagram of a processor of an electronic device, according to an embodiment.

FIG. 6A illustrates coordinate values of reference sound image locations and a target sound image location of an electronic device, according to an embodiment, and FIG. 6B illustrates the coordinate values shown in FIG. 6A in detail.

FIG. 7 is a control flowchart of an electronic device, according to an embodiment.

FIG. 8 illustrates a target sound image location recognized by an electronic device, according to an embodiment.

FIG. 9 is a block diagram of an audio system including an electronic device, according to another embodiment.

FIG. 10 is a control block diagram of an electronic device, according to another embodiment.

### DETAILED DESCRIPTION

It is understood that various embodiments of the disclosure and associated terms are not intended to limit technical features herein to particular embodiments, but encompass various changes, equivalents, or substitutions.

Like reference numerals may be used for like or related elements throughout the drawings.

The singular form of a noun corresponding to an item may include one or more items unless the context states otherwise.

Throughout the specification, “A or B”, “at least one of A and B”, “at least one of A or B”, “A, B or C”, “at least one of A, B and C”, and “at least one of A, B, or C” may each include any one or all the possible combinations of A, B and C.

Terms like “first”, “second”, etc., may be simply used to distinguish an element from another, without limiting the elements in a certain sense (e.g., in terms of importance or order).

When an element is mentioned as being “coupled” or “connected” to another element with or without an adverb “functionally” or “operatively”, it means that the element may be connected to the other element directly (e.g., wiredly), wirelessly, or through a third element.

It will be further understood that the terms “comprise” and/or “comprising,” when used in this specification, specify the presence of stated features, integers, steps, operations, elements, parts or combinations thereof, but do not preclude the possible presence or addition of one or more other features, integers, steps, operations, elements, components, and/or groups thereof.

When an element is mentioned as being “connected to”, “coupled to”, “supported on” or “contacting” another element, it includes not only a case that the elements are directly connected to, coupled to, supported on or contact each other but also a case that the elements are connected to, coupled to, supported on or contact each other through a third element.

Throughout the specification, when an element is mentioned as being located “on” another element, it implies not only that the element is abut on the other element but also that a third element exists between the two elements.

The expression “and/or” is interpreted to include a combination or any of associated elements.

The principle and embodiments of the disclosure will now be described with reference to accompanying drawings.

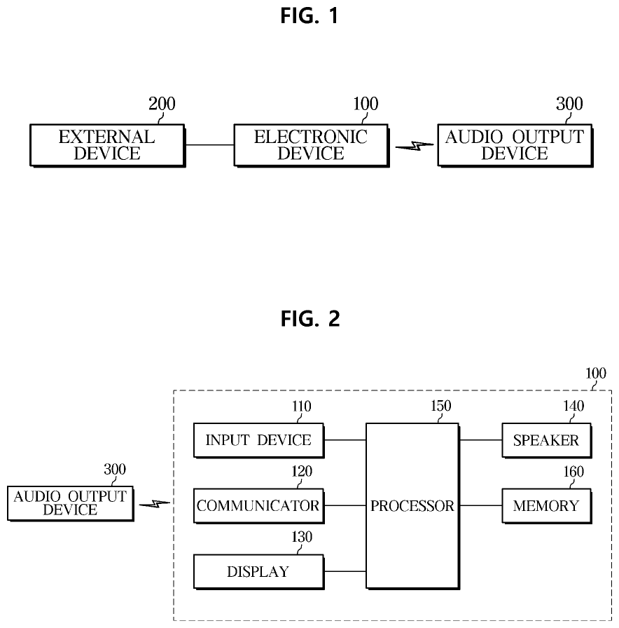

FIG. 1 is a block diagram of an audio system including an electronic device, according to an embodiment.

An electronic device 100 may communicate with an external device 200, output video and audio signals received from the external device 200, output video and audio signals received through communication, or output video and audio signals of content stored in the electronic device 100.

The electronic device 100 may include a television, a user device or a projector, without being limited thereto.

The user device may be carried by the user or placed at the user's home or office. The user device may be implemented as a computer or a portable terminal that is able to access the external device 200 and an audio output device 300 over a network.

The computer may include e.g., a notebook, laptop, tablet personal computer (tablet PC), slate PC, etc., having a WEB browser installed therein, and the portable terminal may be a wireless communication device that guarantees portability and mobility, including any type of handheld based wireless communication device, such as a Personal Communication System (PCS), a Global System for Mobile communications (GSM), a Personal Digital Cellular (PDC), a Personal Handyphone System (PHS), a Personal Digital Assistant (PDA), an International Mobile Telecommunication (IMT)-2000 device, a Code Division Multiple Access (CDMA)-2000 device, a W-CDMA device, a Wireless Broadband Internet (WiBro) terminal, a smart phone, etc., and a wearable device, such as a watch, a ring, a bracelet, a necklace, glasses, a contact lens, a head mounded device (HMD), etc.

When the electronic device 100 is a user device, the user device's memory may store a program, i.e., an application, to control the audio output device 300. The application may be sold in a state of being installed in the user device, or may be downloaded and installed from an external server (not shown).

The user may access the server and create a user account by running the application installed in the user device, and sign up the audio output device 300 by communicating with the server based on the login user account.

For example, when the audio output device 300 is operated according to a procedure guided by the application installed in the user device for the audio output device 300 to access the server, the server may register the audio output device 300 with the user account by registering identification information (e.g., a serial number or a MAC address) of the audio output device 300 with the user account.

The user may use the application installed in the user device to control the audio output device 300. For example, when the user logs in on the user account with the application installed in the user device, the audio output device 300 registered with the user account may appear thereon, and when a control command is input for the audio output device 300, the control command may be forwarded to the audio output device 300 through the server.

The external device 200 transmits video and audio signals of content to the electronic device 100.

The external device 200 may include a set-top box or an external memory device, without being limited thereto.

When the electronic device is a television or a projector, the external device may include a user device.

The electronic device 100 may communicate with the audio output device 300 and transmit an audio signal to the audio output device 300.

The electronic device 100 may create a sound image by performing binaural rendering on an input source based on a transfer function corresponding to a target sound image location, and transmit the created sound image to the audio output device 300. The transfer function may include a head-related transfer function (HRTF).

The input source may be an input audio signal, which may be an audio signal received from the external device 200 or an audio signal stored in the electronic device 100.

The sound image is an audio signal output through the audio output device 300, i.e., an output audio signal.

The audio output device 300 may output a sound image received from the electronic device 100.

The audio output device 300 may include, but not exclusively, a headset, earpieces or a head-mounted display device capable of outputting audio.

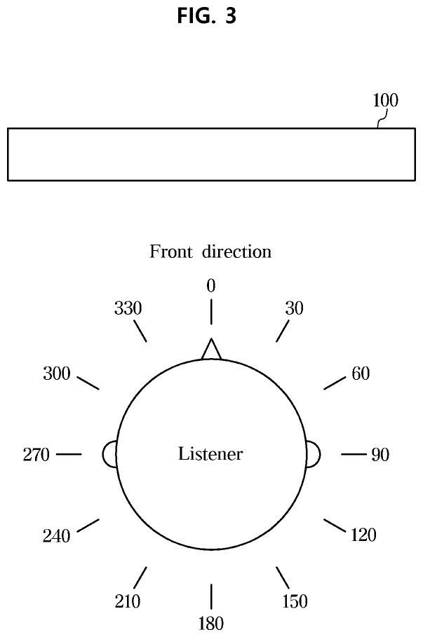

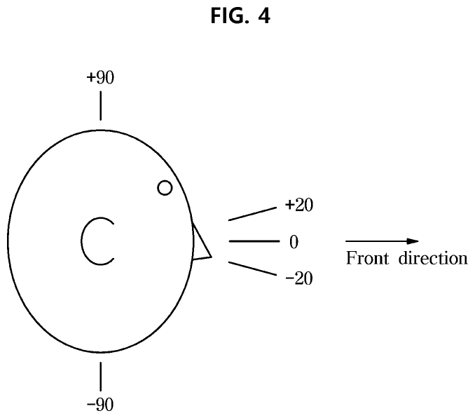

FIG. 2 is a control block diagram of an electronic device, according to an embodiment, which will be described with reference to FIGS. 2 and 3.

FIGS. 3 and 4 illustrate a position of the head of a user who uses an electronic device according to an embodiment.

The electronic device 100 includes an input device 110, a communicator 120, a display 130, a speaker 140, a processor 150 and a memory 160.

The input device 110 receives a user input.

The input device 110 may receive a user input related to an audio output.

The input device 110 may receive a power-on command, a power-off command, an audio play command and an audio stop command.

The input device 110 may receive a volume up command and a volume down command.

The input device 110 may receive a command to select content.

The input device 110 may include a button, a key, a tact switch, a push switch, a slide switch, a toggle switch, a micro switch, a touch switch, a touch pad, a touch screen, a jog dial, etc.

The communicator 120 performs communication with the external device 200 and the audio output device 300.

The communicator 120 may receive an input source from the external device 200 and transmit the received input source to the processor 150.

The communicator 120 may transmit a sound image to the audio output device 300, and receive detection information for the user's head tracking from the audio output device 300.

The communicator 120 may include one or more components that enable communication with the external device 200 and the audio output device 300, for example, at least one of a short-range communication module, a wired communication module, and a wireless communication module.

The short-range communication module may include various short-range communication modules for transmitting and receiving signals within a short range over a wireless communication network, such as Bluetooth module, an infrared communication module, a radio frequency identification (RFID) communication module, a wireless local access network (WLAN) communication module, a near field communication (NFC) module, a Zigbee communication module, etc.

The wired communication module may include not only one of various wired communication modules, such as a local area network (LAN) module, a wide area network (WAN) module, or a value added network (VAN) module, but also one of various cable communication modules, such as a universal serial bus (USB), a high definition multimedia interface (HDMI), a digital visual interface (DVI), recommended standard (RS) 232, a power cable, or a plain old telephone service (POTS).

The wireless communication module may include a wireless fidelity (WiFi) module, a wireless broadband (Wibro) module, and/or any wireless communication device for supporting various wireless communication schemes, such as a global system for mobile communication (GSM) module, a code division multiple access (CDMA) module, a wideband code division multiple access (WCDMA) module, a universal mobile telecommunications system (UMTS), a time division multiple access (TDMA) module, a long term evolution (LTE) module, etc.

The display 130 may display information corresponding to an operation state of the electronic device 100 in response to a control command of the processor 150.

The display 130 may display video information of the content.

The display 130 may also display information corresponding to an operation state of the audio output device 300. For example, the display 130 may display a power-on state, a power-off state, an audio play state, an audio stop state, a battery low state, etc., of the audio output device 300.

The display 130 may include a digital light processing (DLP) panel, a plasma display panel (PDP), a liquid crystal display (LCD) panel, an electro luminescence (EL) panel, an electrophoretic display (EPD) panel, an electrochromic display (ECD) panel, a light emitting diode (LED) panel, an organic light emitting diode (OLED) panel, etc., but is not limited thereto.

The speaker 140 is configured to output an audio signal corresponding to a control command of the processor 150.

The speaker 140 may stop outputting the audio signal in response to a control command of the processor 150.

There may be one or more speakers 140.

The speaker 140 may additionally include a converter that is configured to convert a digital audio signal to an analog audio signal (e.g., a digital-to-analog converter (DAC)).

The processor 150 is configured to control general operation of the electronic device 100.

The processor 150 is configured to power on or off the electronic device 100 based on a user input.

The processor 150 is configured to recognize a command from the user input based on the user input being received from the input device 110, and control an operation of the display 130 based on the recognized command.

The processor 150 is configured to recognize a command from the user input based on the user input being received from the input device 110, and control an operation of the speaker 140 based on the recognized command.

The processor 150 is configured to recognize a command from the user input based on the user input being received from the input device 110, and control an operation of the audio output device 300 based on the recognized command.

The processor 150 is configured to output an audio signal through the speaker 140 or stop outputting the audio signal based on a user input.

The processor 150 is configured to control volume up or volume down of the audio output device 300 based on a user input.

The processor 150 is configured to control connection or disconnection of communication with the audio output device 300 based on a user input.

The processor 150 is configured to recognize a target sound image location for the user's head position based on the detection information received through the communicator 120.

The detection information may include acceleration information detected by an acceleration sensor arranged in the audio output device and angular velocity information detected by a gyro sensor.

The processor 150 is configured to recognize a target azimuth angle and target elevation angle of the head in recognizing the target sound image location.

As shown in FIG. 3, it is assumed that a state of the head that looks at the center of the external device 100 corresponds to a reference state (0 degree), an azimuth angle is a rotated angle of the head when the user turns his/her head to the left or right from the reference state.

As shown in FIG. 4, an elevation angle is an angle that the head moves vertically when the user moves his/her head up or down from the reference state.

The processor 150 is configured to recognize whether there is a reference sound image location equal to the target sound image location among the plurality of reference sound image locations stored in the memory 160, recognize a reference transfer function corresponding to the recognized reference sound image location based on the recognizing of the presence of the reference sound image location equal to the target sound image location, and create a sound image by filtering the recognized reference transfer function and the input source.

Based on the recognizing of absence of a reference sound image location equal to the target sound image location, the processor 150 is configured to create a transfer function corresponding to the target sound image location based on the input source, the target sound image location, pre-stored reference transfer functions and pre-stored initial delays, create a sound image having stereoscopic and spatial effects by filtering the created transfer function, and control the communicator 120 to output the created sound image to the audio output device 300.

The input source may be an input audio signal that is subject to binaural rendering.

The sound image may be an output audio signal. The output audio signal may be a binaural audio signal. For example, the output audio signal may be a two-channel audio signal in which an input audio signal is represented by a virtual sound source located in three dimensional (3D) space.

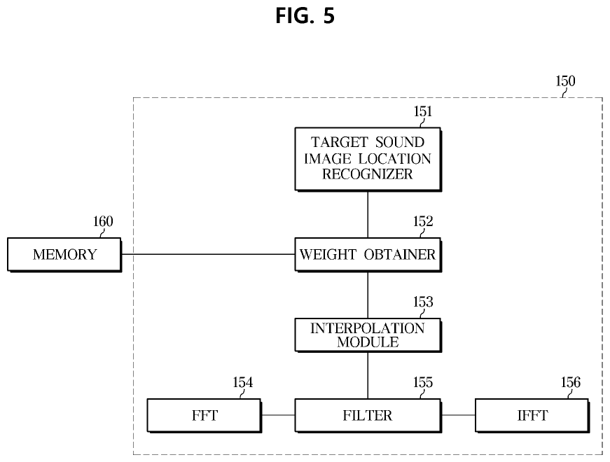

A detailed configuration of the processor 150 will be described later in connection with FIG. 5.

The processor 150 may use data stored in the memory 160 to perform the aforementioned operation.

The processor 150 may include hardware such as a CPU, a memory, etc., and software such as a control program. For example, the processor 150 may include at least one memory for storing data in the form of a program and an algorithm for controlling operations of components in the audio device, and one or more processor chips or one or more processing cores for performing the aforementioned operations by using the data stored in the at least one memory.

The processor 150 may include an extra NPU for performing operations of an AI model.

The memory 160 is configured to store the reference sound image location information, the reference transfer function information, and the initial delay information.

The reference sound image location information may include information about a plurality of reference sound image locations.

The reference transfer function information includes information about a plurality of reference transfer functions corresponding to the plurality of reference sound image locations, respectively.

The initial delay information may include information about a plurality of initial delays corresponding to the plurality of reference sound image locations, respectively.

The plurality of reference sound image locations may include a plurality of reference azimuth angles and a plurality of reference elevation angles.

As shown in FIG. 3, the reference azimuth angles may be set at intervals of 30 degrees and may include 0 to 360 degrees clockwise.

Alternatively, the reference azimuth angles may be set at intervals 45 degrees or 60 degrees, without being limited thereto.

As shown in FIG. 4, the reference elevation angles may be set at intervals of 5 degrees or 10 degrees, and may include −40 to +40 degrees.

The reference elevation angles may be set at intervals of 3 degrees or 6 degrees and may include −30 to +30 degrees, without being limited thereto.

When the plurality of reference sound image locations correspond to (θ1, φ1), (θ2, φ1), (θ3, φ1), (θ1, φ2), . . . , (θi, φj), the plurality of reference transfer functions may include HRTFL(θ1, φ1), HRTFR(θ1, φ1)), . . . , (HRTFL(θi, φj), HRTFR(θi, φj).

When the plurality of reference sound image locations correspond to (θ1, φ1), (θ2, φ1), (θ3, φ1), (θ1, φ2), . . . , (θi, φj), the plurality of initial delays may include DeL(θ1, φ1), DeR(θ1, φ1)), . . . , DeL(θi, φj), DeR(θi, φj).

Based on the volume of the memory 160, the number or amount of information to be stored in the memory 160 may be determined.

Specifically, the number of reference sound image locations corresponding to the plurality of reference transfer functions and the plurality of initial delays may be less than a preset number, and may be determined based on the volume of the memory 160.

The reference transfer function information is information that may be obtained by taking a fast Fourier transform (FFT) on a HRIR signal. Specifically, the reference transfer function information may be obtained by analyzing and modifying the HRIR signal in terms of frequency.

The reference transfer function information includes information about transfer functions for left and right ears when an input source is output at each reference sound image location.

The initial delay information is information about times taken to reach left and right ears from the point in time at which the input source is output in recording the HRIR signal.

The initial delay information is information used in inter-aural time difference (ITD) interpolation with the use of time sample units.

The memory 160 and the processor 150 may be implemented in separate chips. Alternatively, the memory 160 and the processor 150 may be implemented in a single chip.

The memory 160 is configured to store an algorithm for controlling operations of the components in the audio device 100 or data for a program that represents the algorithm.

The memory 160 may be implemented with a non-volatile memory device such as cache, read only memory (ROM), programmable ROM (PROM), erasable programmable ROM (EPROM), electrically erasable programmable ROM (EEPROM) and flash memory, or a volatile memory device such as random access memory (RAM) and dynamic RAM (DRAM), without being limited thereto.

At least one component may be added to or omitted from the electronic device to correspond to the performance of the electronic device as shown in FIG. 2. Furthermore, it will be obvious to those of ordinary skill in the art that the relative positions of the components may be changed to correspond to the system performance or structure.

The components shown in FIG. 2 may refer to software and/or hardware components such as field programmable gate arrays (FPGAs) and application specific integrated circuits (ASICs).

FIG. 5 is a detailed block diagram of a processor of an electronic device, according to an embodiment.

The processor 150 of the electronic device includes a target sound image location recognizer 151, a weight obtainer 152, an interpolation module 153, an FFT module 154, a filter 155, and an inverse FFT (IFFT) module 156.

The target sound image location recognizer 151 is configured to recognize a current head location of the user based on the detection information received from the audio output device 300.

The current head position of the user may be a target sound image location.

The detection information is information about a motion of the head of the user, and may include acceleration information and an angular velocity information.

Specifically, the target sound image location recognizer 151 may recognize the target sound image location of the user based on the acceleration information and angular velocity information detected by the audio output device.

The target sound image location of the user may be an extent to which the head position is changed from a reference point when the user moves his/her head.

The target sound image location of the user may include a target azimuth angle θtar and a target elevation angle φtar.

The target sound image location recognizer 151 is configured to transmit the recognized target sound image location to the weight obtainer 152.

The weight obtainer 152 is configured to determine a preset number of reference azimuth angles in a sequence of having a smaller difference in azimuth from the target azimuth angle among the plurality of reference azimuth angles, determine a preset number of reference elevation angles in a sequence of having a smaller difference in elevation from the target elevation angle among the plurality of reference elevation angles, and determine a plurality of indexes based on the determined preset number of reference azimuth angles and the determined preset number of reference elevation angles.

It is also possible that the weight obtainer 152 determines the plurality of indexes to be separated into azimuth indexes and elevation indexes.

The weight obtainer 152 is configured to determine the plurality of azimuth indexes based on the plurality of reference azimuth angles and the target azimuth angle θtar.

There may be two or more azimuth indexes. In the embodiment, an example of determining two azimuth indexes will be described.

The weight obtainer 152 is configured to recognize those of the reference azimuth angles, which are smaller than the target azimuth angle as first reference azimuth angles, obtain first azimuth differences between the first reference azimuth angles and the target azimuth angle, and determine a first reference azimuth angle having the smallest of the obtained first azimuth differences as a first azimuth index.

The weight obtainer 152 is configured to recognize those of the reference azimuth angles, which are larger than the target azimuth angle, as second reference azimuth angles, obtain second azimuth differences between the second reference azimuth angles and the target azimuth angle, and determine a second reference azimuth angle having the smallest of the obtained second azimuth differences as a second azimuth index.

The weight obtainer 152 is configured to determine a plurality of pieces of elevation index information based on the plurality of reference elevation angles and the target elevation angle φtar.

There may be two or more elevation indexes. In the embodiment, an example of determining two elevation indexes will be described.

The weight obtainer 152 is configured to recognize those of the reference elevation angles, which are smaller than the target elevation angle, as first reference elevation angles, obtain first elevation differences between the first reference elevation angles and the target elevation angle, and determine a first reference elevation angle having the smallest of the obtained first elevation differences as a first elevation index.

The weight obtainer 152 is configured to recognize those of the reference elevation angles, which are larger than the target elevation angle as second reference elevation angles, obtain second elevation differences between the second reference elevation angles and the target elevation angle, and determine a second reference elevation angle having the smallest of the obtained second elevation differences as a second elevation index.

The weight obtainer 152 is configured to obtain a first weight based on the target azimuth angle θtar and the first azimuth index θin1, and obtain a second weight based on the target azimuth angle θtar and the second azimuth index θin2

First weight (We1)=1−(θtar−θin1)/((θtar−θin1)+(θin2−θtar))

Second weight (We2)=1−(θin2−θtar)/((θtar−θin1)+(θin2−θtar))

The weight obtainer 152 may obtain the first and second weights based on an absolute value of the first azimuth difference between the target azimuth angle and the first azimuth index and an absolute value of the second azimuth difference between the target azimuth angle and the second azimuth index.

The weight obtainer 152 is configured to obtain a third weight based on the target elevation angle and the first elevation index, and a fourth weight based on the target elevation angle and the second elevation index.

The weight obtainer 152 may obtain the third and fourth weights based on an absolute value of the first elevation difference between the target elevation angle and the first elevation index and an absolute value of the second elevation difference between the target elevation angle and the second elevation index.

Third weight (We3)=1−(φtar−φin1)/((φtar−φin1)+(φin2−φtar))

Fourth weight (We4)=1−(φin2−φtar)/((φtar−φin1)+(φin2−φtar))

The interpolation module 153 is configured to perform magnitude interpolation and delay interpolation.

The magnitude interpolation is obtaining inter-aural loudness difference (ILD) interpolation.

The magnitude refers to a magnitude of a signal for each frequency delivered to left and right ears from the target sound image location, and may be a numerical value that represents intensity of an HRIR signal for each frequency. The magnitude may be an absolute value.

The delay interpolation is obtaining an inter-aural time difference (ITD).

An example of a configuration of the interpolation module will be described.

The interpolation module 153 is configured to obtain first and second reference transfer functions corresponding to the first and second azimuth indexes and obtain third and fourth reference transfer functions corresponding to the first and second elevation indexes based on the information stored in the memory 160.

The interpolation module 153 is configured to obtain a first magnitude based on the first and second indexes and the first and second reference transfer functions, and obtain a second magnitude based on the first and second elevation indexes and the third and fourth reference transfer functions. The first magnitude is a magnitude obtained for creating a first interpolation transfer function, and the second magnitude is a magnitude obtained for creating a second interpolation transfer function.

The interpolation module 153 is configured to create the first interpolation transfer function based on the first and second weights, the first and second azimuth indexes, the first and second reference transfer functions and the first magnitude, and create the second interpolation transfer function based on the third and fourth weights, the first and second elevation indexes, the third and fourth reference transfer functions and the second magnitude.

The interpolation module 153 is configured to obtain first and second initial delays corresponding to the first and second azimuth indexes and third and fourth initial delays corresponding to the first and second elevation indexes based on the information stored in the memory 160, obtain a first adjusted delay based on the first and second weights, the first interpolation transfer function and the first and second initial delays, and obtain a second adjusted delay based on the third and fourth weights, the second interpolation transfer function and the third and fourth initial delays.

The interpolation module 153 may create a third interpolation transfer function based on the first and second interpolation transfer functions, and obtain a third adjusted delay based on the first and second adjusted delays.

The interpolation module 153 may create a target transfer function based on the third interpolation transfer function and the third adjusted delay.

In other words, the interpolation module 153 may create the target transfer function based on the first and second weights, the first and second azimuth indexes, the third and fourth weights, the first and second elevation indexes, the first, second, third, and fourth reference transfer functions and the first, second, third and fourth initial delays. This will be described in more detail.

The interpolation module 153 may obtain the first magnitude Mag1 based on the first and second weights We1 and We2 and the magnitudes of the first and second reference transfer functions corresponding to the first and second azimuth indexes θin1 and θin2, and obtain the second magnitude Mag2 based on the third and fourth weights We3 and We4 and the magnitudes of the third and fourth reference transfer functions corresponding to the first and second elevation indexes φin1 and φin2.

Each of the first, second, third and fourth reference transfer functions may include a reference transfer function HRTFL corresponding to the left ear and a reference transfer function HRTFR corresponding to the right ear.

The first magnitude may be a magnitude of the first interpolation transfer function corresponding to the target azimuth angle θtar.

The second magnitude may be a magnitude of the second interpolation transfer function corresponding to the target elevation angle φtar.

The first and second magnitudes to be used in magnitude interpolation are as follows:

Mag1(HRTFL(θtar,0),HRTFR(θtar,0))=We1×mag(HRTFL(θin1,0),HRTFR(θin1,0))+We2×mag(HRTFL(θin2,0),HRTFR(θin2,0))

Mag2(HRTFL(θ,φtar),HRTFR(θ,φtar))=We31×mag(HRTFL(θ,φin1),HRTFR(θ,φin1))+We4×mag(HRTFL(θ,φin2),HRTFR(θ,φin2))

The interpolation module 153 is configured to compare the first and second weights to identify whether the first weight is larger than the second weight or the second weight is larger than the first weight.

When the first weight is larger than the second weight, the interpolation module 153 obtains the first azimuth index corresponding to the first weight, obtains a phase of the first reference transfer function corresponding to the first azimuth index, and creates the first interpolation transfer function based on the obtained phase of the first reference transfer function and the obtained first magnitude.

The identified reference transfer function may include a reference transfer function HRTFL corresponding to the left ear and a reference transfer function HRTFR corresponding to the right ear.

When the first weight is larger than the second weight, the identified phase of the reference transfer function is as follows:

Phase(HRTFL(θin_c,0),HRTFR(θin_c,0))=Phase(HRTFL(θin1,0),HRTFR(6in1,0))

When the second weight is larger than the first weight, the interpolation module 153 obtains the second azimuth index corresponding to the second weight, obtains a phase of the second reference transfer function corresponding to the second azimuth index, and creates the first interpolation transfer function based on the obtained phase of the second reference transfer function and the obtained first magnitude.

When the second weight is larger than the first weight, the phase of the identified reference transfer function is as follows:

Phase(HRTFL(θin_c,0),HRTFR(θin_c,0))=Phase(HRTFL(θin2,0),HRTFR(θin2,0))

Specifically, the interpolation module 153 may identify the larger one of the first and second weights, and create the first interpolation transfer function based on the first magnitude and the phase of the reference transfer function corresponding to the identified weight.

The phase may refer to a phase for each frequency of a head impulse response signal.

The first interpolation transfer function may be an azimuth related interpolation transfer function.

The phase of the reference transfer function may be a phase with an initial delay applied thereto, and the initial delay may be stored in the memory 160.

The interpolation module 153 is configured to obtain first and second initial delays corresponding to the first and second azimuth indexes based on the information stored in the memory 160, and obtain a first adjusted delay based on the obtained first and second initial delays and the first and second weights.

Each of the first and second initial delays may include an initial delay DeL corresponding to the left ear and an initial delay DeR corresponding to the right ear.

The first adjusted delay may include a first adjusted delay ΔDeL1 corresponding to the left ear and a first adjusted delay ΔDeR1 corresponding to the right ear.

The first adjusted delay ΔDe to be used for delay interpolation is as follows:

(ΔDeL1,ΔDeR1)={(DeL(θin_i,0),DeR(θin_i,0))−(DeL(θin_c,0),DeR(θin_c,0))}×We_i

where in_c is an azimuth index with a large weight, and in_i is an azimuth index with a small weight.

The interpolation module 153 is configured to compare the third and fourth weights to identify whether the third weight is larger than the fourth weight or the fourth weight is larger than the third weight.

When the third weight is larger than the fourth weight, the interpolation module 153 obtains the first elevation index corresponding to the third weight, obtains a phase of the third reference transfer function corresponding to the first elevation index, and creates the second interpolation transfer function based on the obtained phase of the third reference transfer function and the obtained second magnitude.

When the third weight is larger than the fourth weight, the phase of the identified reference transfer function is as follows:

Phase(HRTFL(θ,φin_c,HRTFR(θ,φin_c))=Phase(HRTFL(θ,φin1),HRTFR(θ,φin1))

When the fourth weight is larger than the third weight, the interpolation module 153 obtains the second elevation index corresponding to the fourth weight, obtains a phase of the fourth reference transfer function corresponding to the second elevation index, and creates the second interpolation transfer function based on the obtained phase of the fourth reference transfer function and the second magnitude.

When the fourth weight is larger than the third weight, the phase of the identified reference transfer function is as follows:

Phase(HRTFL(θ,φin_c),HRTFR(θ,φin_c))=Phase(HRTFL(θ,φin2),HRTFR(θ,φin2))

Specifically, the interpolation module 153 is configured to identify the larger of the third and fourth weights, and create the second interpolation transfer function based on the second magnitude and the phase of the reference transfer function corresponding to the identified weight.

The second interpolation transfer function may be an elevation related interpolation transfer function.

The interpolation module 153 is configured to obtain third and fourth initial delays corresponding to the first and second elevation indexes based on the information stored in the memory 160, and obtain a second adjusted delay based on the obtained third and fourth initial delays and the third and fourth weights.

The second adjusted delay may include a second adjusted delay ΔDeL2 corresponding to the left ear and a second adjusted delay ΔDeR2 corresponding to the right ear.

The second adjusted delay to be used for delay interpolation is as follows:

(ΔDeL2,ΔDeR2)={(DeL(θ,φin_i),DeR(θ,φin_i))−(DeL(θ,φin_c),DeR(θ,φin_c))}×We_i

where in_c is an elevation index with a large weight, and in_i is an elevation index with a small weight.

The interpolation module 153 may create a third interpolation transfer function based on the first and second interpolation transfer functions, and obtain a third adjusted delay based on the first and second adjusted delays.

The interpolation module 153 is configured to create a target transfer function based on the third interpolation transfer function and the third adjusted delay.

The interpolation module 153 may create a target transfer function by multiplying the third interpolation transfer function by

$${e}^{\frac{- j 2 π k Δ De}{N}} .$$

The target transfer function may be a target head transfer function.

$$H R I R [ s - Δ De ] ↔ {e}^{\frac{- j 2 π k Δ De}{N}} H R T F [ k ]$$

The above equation represents a time delay on the frequency axis.

An example of creating the target transfer function is about creating the target transfer function after the interpolation transfer function is created by differentiating between azimuth and elevation.

Specifically, in this example, the respective weights are obtained based on the first and second reference azimuth angles and the first and second reference elevation angles, and the target transfer function is obtained based on the first, second, third and fourth transfer functions and the first, second, third and fourth initial delays.

In a modified example, it is also possible that the first, second, third and fourth indexes (θin1, φin1), (θin1, φin2), (θin2, φin1) and (θin2, φin2) are obtained by combinations of the first and second reference azimuth angles (θin1, θin2) and the first and second reference elevation angles (φin1, φin2), that the respective weights for the indexes are obtained, that the first, second, third and fourth initial delays and the first, second, third and fourth transfer functions corresponding to the first, second, third and fourth indexes are obtained, and that the target transfer function is obtained based on the first, second, third and fourth transfer functions and the first, second, third and fourth initial delays.

Another example of a configuration of the interpolation module will be described.

In another example of creating the target transfer function, an interpolation transfer function is created by taking into account both the azimuth and the elevation, and then a target transfer function is created.

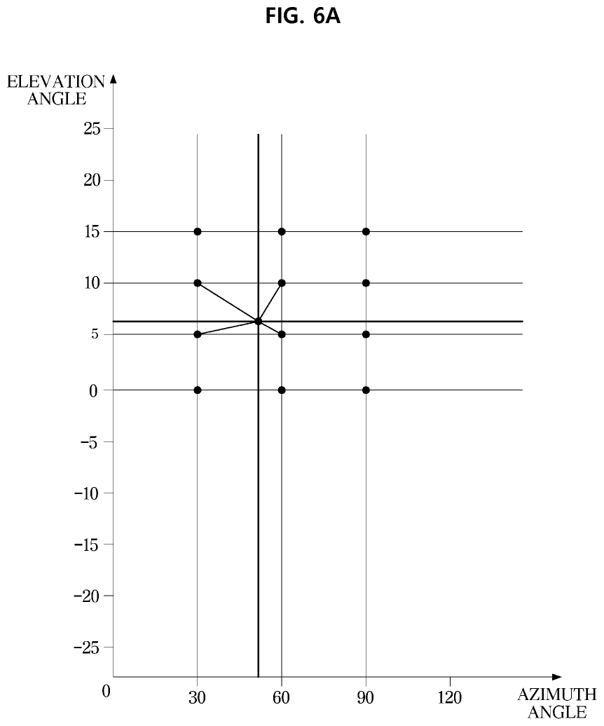

As shown in FIGS. 6A and 6B, when the azimuth angle and the elevation angle are implemented on the x-axis and the y-axis, respectively, the weight obtainer 152 may determine a plurality of indexes based on distances between the coordinate value (θtar, φtar) of the target sound image location and coordinate values of the reference sound image locations, and obtain weights based on distances between coordinate values of the determined indexes and the coordinate value of the target sound image location.

The weight obtainer 152 is configured to obtain distances between the coordinate value (θtar, φtar) of the target sound image location and the coordinate values of the reference sound image locations, list the obtained distances in a sequence of having lower values, obtain a preset number of distances in higher places in the sequence among the listed distances, and obtain coordinate values of reference sound image locations having the obtained distances as indexes.

In a case of obtaining two indexes, the weight obtainer 152 may obtain a coordinate value (θin1, φin1) of a reference sound image location of one of the determined two indexes as a first index, and obtain a coordinate value (θin2, φin2) of a reference sound image location of the other as a second index.

The weight obtainer 152 is configured to obtain a first weight for the first index and a second weight for the second index based on a distance d1 between the coordinate value (θtar, φtar) of the target sound image location and the coordinate value (θin1, φin1) of the first index and a distance d2 between the coordinate value (θtar, φtar) of the target sound image location and the coordinate value (θin2, φin2) of the second index.

First weight (We1)=1−(d1/(d1+d2))

Second weight (We2)=1−(d2/(d1+d2))

The interpolation module 153 is configured to obtain the first reference transfer function corresponding to the first index and the second reference transfer function corresponding to the second index based on the information stored in the memory 160, and obtain a magnitude mag based on first and second weights and magnitudes of the obtained first and second reference transfer functions. The obtained magnitude may be one for creating an interpolation transfer function.

Each of the first and second reference transfer functions may include a reference transfer function HRTFL corresponding to the left ear and a reference transfer function HRTFR corresponding to the right ear.

mag(HRTFL(θtar,φtar),HRTFR(θtar,φtar))=we1×mag(HRTFL(θin1,φin1),HRTFR(θin1,φn1))+we2×mag(HRTFL(θin2,φin2),HRTFR(θin2,φin2))

The interpolation module 153 is configured to compare the first and second weights to identify whether the first weight is larger than the second weight or the second weight is larger than the first weight.

When the first weight is larger than the second weight, the interpolation module 153 obtains the first index corresponding to the first weight, obtains a phase of the first reference transfer function corresponding to the first index, and creates the interpolation transfer function based on the obtained phase of the first reference transfer function and the obtained magnitude.

When the first weight is larger than the second weight, the phase of the reference transfer function is as follows:

Phase(HRTFL(θin_c,φin_c),HRTFR(θin_c,φin_c))=Phase(HRTFL(θin1,φin1),HRTFR(θin1,φin1))

When the second weight is larger than the first weight, the interpolation module 153 obtains the second index corresponding to the second weight, obtains a phase of the second reference transfer function corresponding to the second index, and creates an interpolation transfer function based on the obtained phase of the second reference transfer function and the obtained magnitude.

When the second weight is larger than the first weight, the phase of the reference transfer function is as follows:

Phase(HRTFL(θin_c,φin_c),HRTFR(θin_c,φin_c))=Phase(HRTFL(θin2,φin2),HRTFR(θin2,φin2))

The interpolation module 153 is configured to identify the larger of the first and second weights, and create the interpolation transfer function based on the obtained magnitude and the phase of the reference transfer function corresponding to the identified weight.

The interpolation module 153 is configured to obtain first and second initial delays corresponding to the first and second indexes based on the information stored in the memory 160, and obtain an adjusted delay based on the obtained first and second initial delays and the first and second weights.

Each of the first and second initial delays may include an initial delay DeL corresponding to the left ear and an initial delay DeR corresponding to the right ear.

The adjusted delay may include an adjusted delay ΔDeL corresponding to the left ear and an adjusted delay ΔDeR corresponding to the right ear.

(ΔDeL,ΔDeR)={(DeL(θin_i,φin_i),DeR(θin_i,φin_i))−(DeL(θin_c,φin_c),DeR(θin_c,φin_c))}×we_i

where in_c is an index with a large weight, and in_i is an index with a small weight.

The interpolation module 153 may create a target transfer function based on the interpolation transfer function and the adjusted delay.

The interpolation module 153 may create the target transfer function by multiplying the interpolation transfer function by

$${e}^{\frac{- j 2 π k Δ De}{N}} .$$

The target transfer function may be a final interpolation transfer function or a target head transfer function.

$$HRIR [ s - Δ De ] ↔ {e}^{\frac{- j 2 π k Δ De}{N}} H R T F [ k ]$$

The above equation represents a time delay on the frequency axis.

The FFT module 154 is configured to convert a signal of the input source into the frequency domain by applying FFT on the input source received from the external device 200.

The FFT module 154 is configured to transmit the converted audio signal in the frequency domain to the filter 155.

The filter 155 is configured to create left and right audio signals based on the converted audio signal and the left and right target transfer functions created by the interpolation module 153.

The left and right audio signals created by the filter 155 may be signals in the frequency domain.

The filter 155 is configured to transmit the created left and right audio signals to the IFFT module 156.

The IFFT module 156 is configured to create left and right output audio signals by applying IFFT to the left and right audio signals received from the filter 155.

The IFFT module 156 is configured to convert the audio signal created by the filter 155 back into the time domain. The audio signal converted by the IFFT module 156 may be an output audio signal in the time domain. The output audio signal may be a sound image.

The audio signal converted by the IFFT module 156 may be transmitted to the audio output device 300 through the communicator 120.

The left audio signal converted by the IFFT module 156 may be transmitted to the audio output device 300 on the left through the communicator 120, and the right audio signal converted by the IFFT module 156 may be transmitted to the audio output device 300 on the right through the communicator 120.

In the embodiment, by outputting a sound image based on information about a preset number of reference sound image locations and the target sound image location, the sound image desired by the user may always be output even when the user moves his/her head at many different angles.

In the embodiment, the head transfer function was described as an example.

The transfer function may include at least one of an inter-aural transfer function (ITF), a modified ITF (MITF), a binaural room transfer function (BRTF), a room impulse response (RIR), a binaural room impulse response (BRIR), a head related impulse response (HRIR) and the modified and edited data.

For example, the transfer function may include a secondary binaural transfer function obtained by linearly combining the plurality of binaural transfer functions.

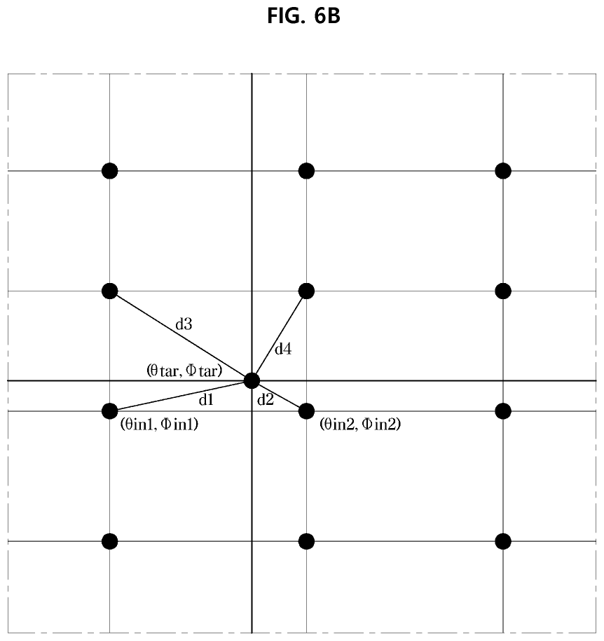

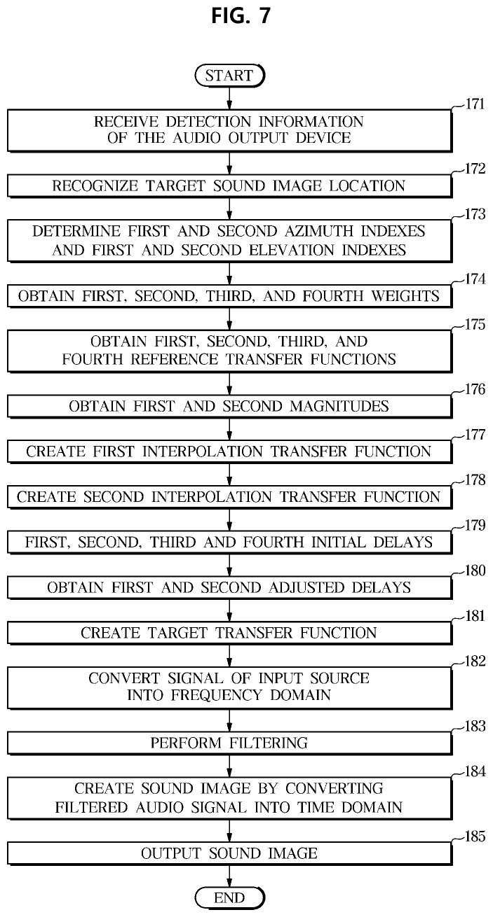

FIG. 7 is a control flowchart of an electronic device, according to an embodiment, which will be described with reference to FIG. 8.

The electronic device receives detection information from the audio output device, in 171.

The detection information may include acceleration information and angular velocity information.

The electronic device recognizes a target sound image location of the user based on the received acceleration information and angular velocity information, in 172.

The target sound image location of the user may include a target azimuth angle θtar and a target elevation angle φtar.

The electronic device may recognize a plurality of indexes based on the plurality of reference sound image locations and the target sound image location.

Each of the reference sound image locations may include a reference azimuth angle and a reference elevation angle.

The electronic device may determine a plurality of azimuth indexes based on the plurality of reference azimuth angles and the target azimuth angle, and determine a plurality of elevation indexes based on the plurality of reference elevation angles and the target elevation angle.

For example, the electronic device determines first and second azimuth indexes and first and second elevation indexes, in 173. This will be described in more detail.

The electronic device recognizes those of the reference azimuth angles, which are smaller than the target azimuth angle, as first reference azimuth angles, obtains first azimuth differences between the first reference azimuth angles and the target azimuth angle, and determines a first reference azimuth angle having the smallest of the obtained first azimuth differences as a first azimuth index.

The electronic device recognizes those of the reference azimuth angles, which are larger than the target azimuth angle, as second reference azimuth angles, obtains second azimuth differences between the second reference azimuth angles and the target azimuth angle, and determines a second reference azimuth angle having the smallest of the obtained second azimuth differences as a second azimuth index.

The electronic device recognizes those of the reference elevation angles, which are smaller than the target elevation angle, as first reference elevation angles, obtains first elevation differences between the first reference elevation angles and the target elevation angle, and determines a first reference elevation angle having the smallest of the obtained first elevation differences as a first elevation index.

The electronic device recognizes those of the reference elevation angles, which are larger than the target elevation angle, as second reference elevation angles, obtains second elevation differences between the second reference elevation angles and the target elevation angle, and determines a second reference elevation angle having the smallest of the obtained second elevation differences as a second elevation index.

As shown in FIG. 8, when the reference azimuth angles are 0, 30, 60, 90, 120, 150, 180, 210, 240, 270, 300, 330 and 360 (=0) degrees, and the target azimuth angle is 50 degrees, the electronic device may determine 30 degrees as a first azimuth index and 60 degrees as a second azimuth index among the reference azimuth angles.

When the reference elevation angles are 0, 5, 10, 15, 20, 25, 30, −5, −10, −15, −20, −25 and −30, and the target elevation angle is 6 degrees, the electronic device may determine 5 degrees as a first elevation index and 10 degrees as a second elevation index among the reference elevation angles.

The electronic device obtains first, second, third, and fourth weights based on the target azimuth angle, the first azimuth index, the second azimuth index, the target elevation angle, the first elevation index and the second elevation index, in 174.

Specifically, the electronic device obtains the first weight based on the target azimuth angle and the first azimuth index, and obtains the second weight based on the target azimuth angle and the second azimuth index.

The electronic device obtains the third weight based on the target elevation angle and the first elevation index, and the fourth weight based on the target elevation angle and the second elevation index.

When the target elevation angle is 0 degree, the electronic device may not determine the elevation index. In this case, it is also possible that the first azimuth index and the second azimuth index are determined as the first and second indexes, respectively, and only the first and second weights are obtained while obtaining the third and fourth weights is skipped.

For example, when the target sound image location is (50, 0), the first index is (30, 0), and the second index is (60, 0), the first weight for the first index and the second weight for the second index are as follows:

First weight=1−(50−30)/((50−30)+(60−50))=0.333333

Second weight=1−(60−50)/((50−30)+(60−50))=0.666666

The electronic device obtains first and second reference transfer functions corresponding to the first and second azimuth indexes θin1 and θin2, and obtains third and fourth reference transfer functions corresponding to the first and second elevation indexes φin1 and φin2, in 175.

The electronic device may obtain the first magnitude Mag1 based on the first and second weights We1 and We2 and the magnitudes of the first and second reference transfer functions, and obtain the second magnitude Mag2 based on the third and fourth weights We3 and We4 and the magnitudes of the third and fourth reference transfer functions, in 176.

The magnitudes of the respective reference transfer functions may be information stored in the memory in advance.

Each of the reference transfer functions may include a reference transfer function HRTFL corresponding to the left ear and a reference transfer function HRTFR corresponding to the right ear.

The magnitude of the first reference transfer function corresponding to the first azimuth index θin1 and the magnitude of the second reference transfer function corresponding to the second azimuth index θin2 are assumed to be as follows:

mag(HRTFL_1000Hz(30,0),HRTFR_1000Hz(30,0))=(0.4,0.7)

mag(HRTFL_1000Hz(60,0),HRTFR_1000Hz(60,0))=(0.3,0.75)

In this case, left and right magnitudes at 1,000 Hz are as follows:

Mag1(HRTFL_1000Hz(50,0),HRTFR_1000Hz(50,0))=(0.4×0.333+0.3×0.666,0.7×0.333+0.75×0.666)=(0.333,0.733)

The electronic device is configured to compare the first and second weights to identify whether the first weight is larger than the second weight or the second weight is larger than the first weight.

The electronic device may identify the larger of the first and second weights, obtain an azimuth index corresponding to the identified weight, and create a first interpolation transfer function based on the first magnitude and the phase of the reference transfer function corresponding to the obtained azimuth index θin_c, in 177.

The electronic device may identify the larger of the third and fourth weights, obtain an elevation index corresponding to the identified weight, and create a second interpolation transfer function based on the second magnitude and the phase of the reference transfer function corresponding to the obtained elevation index φin_c, in 178.

The identified reference transfer function may include a reference transfer function HRTFL corresponding to the left ear and a reference transfer function HRTFR corresponding to the right ear.

The phase of each reference transfer function may be a phase with an initial delay applied thereto, and the initial delay may be stored in the memory 160.

Specifically, the electronic device may obtain first and second initial delays corresponding to the first and second azimuth indexes based on the information stored in the memory 160, and obtain third and fourth initial delays corresponding to the first and second elevation indexes, in 179.

The electronic device is configured to obtain a first adjusted delay based on the obtained first and second initial delays and the first and second weights, and obtain a second adjusted delay based on the obtained third and fourth initial delays and the third and fourth weights, in 180.

Each of the initial delays may include an initial delay DeL corresponding to the left ear and an initial delay DeR corresponding to the right ear.

The first and second adjusted delays may include first and second adjusted delays ΔDeL1 and ΔDeL2 corresponding to the left ear and second adjusted delays ΔDeR1 and ΔDeR2 corresponding to the right ear.

The first adjusted delay to be used for delay interpolation is as follows:

(ΔDeL1,ΔDeR1)={(DeL(θin_i,0),DeR(0in_i,0))−(DeL(θin_c,0),DeR(θin_c))}×We_i

The second adjusted delay to be used for delay interpolation is as follows:

(ΔDeL2,ΔDeR2)={(DeL(θ,φin_i),DeR(θ,φin_i))−(DeL(θ,φin_c),DeR(θ,φin_c))}×We_i

where in_c is an elevation index with a large weight, and in_i is an elevation index with small weight.

The electronic device may create a third interpolation transfer function based on the first and second interpolation transfer functions, and obtain a third adjusted delay based on the first and second adjusted delays.

An example of obtaining the first adjusted delay will be described. It is assumed that the first and second initial delays obtained from the memory are as follows:

(DeL(30,0),DeR(30,0))=(90,60)

(DeL(60,0),DeR(60,0))=(100,50)

In this case, the first adjusted delay is as follows:

(ΔDeL1,ΔDeR1)=((90,60)−(100,50))×0.333=(−3.333,3.333)

The electronic device creates a target transfer function to be applied to a signal of the input source by multiplying the third adjusted delay and the third interpolation transfer function by

$${e}^{\frac{- j 2 π k Δ De}{N}} ,$$

in 181.

The delay in time is represented on the frequency axis as follows:

$$HRIR [ s - Δ De ] ↔ {e}^{\frac{- j 2 π k Δ De}{N}} H R T F [ k ] ,$$

where s is a time sample.

The electronic device is configured to convert a signal of the input source into the frequency domain by applying FFT on the input source received from the external device 200, in 182.

The electronic device performs filtering to generate left and right audio signals based on the converted audio signal and the generated left and right target transfer functions, in 183.

The electronic device creates a sound image by applying IFFT to the filtered left and right audio signals to convert the left and right output audio signals into the time domain, in 184.

The electronic device is configured to output the converted audio signals to the audio output device 300 through the communicator 120, in 185.

The converted left audio signal may be transmitted to the audio output device 300 on the left through the communicator 120, and the right audio signal converted by the IFFT module 156 may be transmitted to the audio output device 300 on the right through the communicator 120.

In the embodiment, by outputting a sound image based on information about a preset number of reference sound image locations and the target sound image location, the sound image desired by the user may always be output even when the user moves his/her head at many different angles.

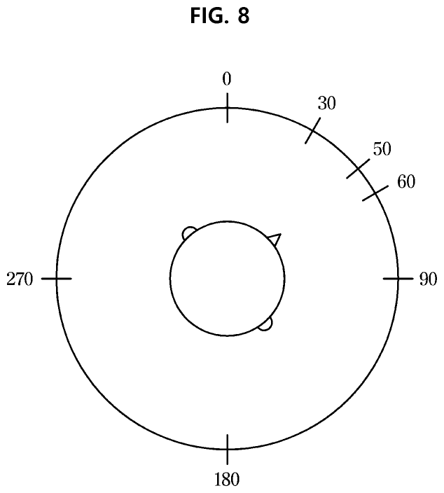

FIG. 9 is a block diagram of an audio system including an electronic device, according to another embodiment.

The audio system includes an electronic device 400 and an external device 500.

The electronic device 400 may communicate with the external device 500.

The external device 500 may output a video signal and an audio signal received from the outside or output video and audio signals of content stored inside.

The external device 500 may transmit the audio signal to the electronic device 400.

The external device 500 may include a television, a user device or a projector, without being limited thereto.

The user device may be carried by the user or placed at the user's home or office. The user device may include a personal computer, a terminal, a portable telephone, a smart phone, a handheld device, a wearable device, etc., without being limited thereto.

The personal computer may include a desktop, a laptop and a tablet PC.

In the memory of the user device, a program for controlling the electronic device 400, i.e., an application, may be stored. The application may be sold in a state of being installed in the user device, or may be downloaded and installed from an external server (not shown).

The user may access a server and create a user account by running the application installed in the user device, and sign up the electronic device 400 by communicating with the server based on the login user account.

For example, when the electronic device 400 is operated according to a procedure guided by the application installed in the user device for the electronic device 400 to access the server, the server may register the electronic device 400 with the user account by registering identification information (e.g., a serial number or a MAC address) of the electronic device 400 with the user account.

The user may use the application installed in the user device to control the electronic device 400. For example, when the user logs in on the user account with the application installed in the user device, the electronic device 300 registered with the user account may appear thereon, and when a control command is input for the audio device 100, the control command may be forwarded to the electronic device 300 through the server.

The electronic device 400 may detect a target sound image location corresponding to a motion of the user's head, generate a sound image by binaural-rendering on the input source based on a transfer function corresponding to the detected target sound image location, and output the generated sound image. The transfer function may include a head-related transfer function (HRTF).

The input source may be an input audio signal, which may be an audio signal received from the external device 500.

The sound image may be an audio signal output through the electronic device 400, i.e., an output audio signal.

The electronic device 400 may include, but not exclusively, a headset, earpieces or a head-mounted display device capable of outputting audio.

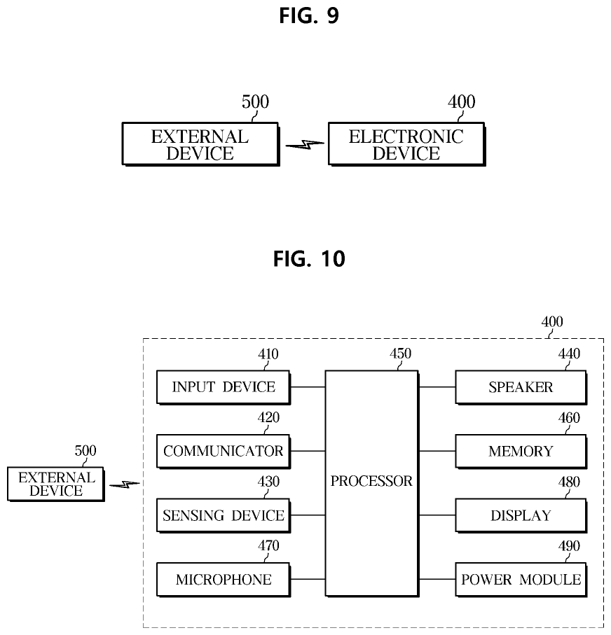

FIG. 10 is a control block diagram of an electronic device, according to another embodiment.

The electronic device 400 includes an input device 410, a communicator 420, a sensing device 430, a speaker 440, a processor 450 and a memory 460.

The input device 410 is configured to receive a user input.

The input device 410 is configured to receive a user input related to an audio output.

The input device 410 is configured to receive a power-on or off command, an audio play command, an audio stop command.

The input device 410 is configured to receive a volume up command or a volume down command.

The input device 410 is configured to receive a call connection command and a call termination command.

The input device 410 is configured to receive a command to select an audio mode or a call mode.

The input device 410 may include a button, a key, a tact switch, a push switch, a slide switch, a toggle switch, a micro switch, a touch switch, a touch pad, a touch screen, a jog dial, etc.

The communicator 420 is configured to communicate with the external device 500.

The communicator 420 is configured to receive an input source from the external device 500 and transmit the received input source to the processor 450. The input source may include an input audio signal.

The communicator 420 may support establishment of a direct (e.g., wired) communication channel or a wireless communication channel with the external device 500, and communication through the established communication channel.

The configuration of the communicator 420 is the same as the communicator 120 of an embodiment, so the description will not be repeated.

The sensing device 430 is configured to detect information about the motion of the user's head for head tracking and transmits the detected detection information to the processor 450.

The information about the motion of the head is information about a target sound image location, which may include a target azimuth angle and a target elevation angle.

The sensing device 430 may include at least one of an acceleration sensor and a gyro sensor for detecting a motion of the user's head.

The acceleration sensor is configured to detect direction and speed of the motion of the head.

The gyro sensor is configured to detect angular velocity of the motion of the head.

The speaker 440 is configured to output a sound image corresponding to a control command of the processor 450. The sound image may include an output audio signal.

There may be one or more speakers 440.

The output audio signal may be two-channel output audio signals corresponding to both ears of the user, respectively.

The output audio signal may be a binaural two-channel output audio signal.

The speaker 440 may additionally include a converter that converts a digital audio signal to an analog audio signal (e.g., a digital-to-analog converter (DAC)).

The processor 450 is configured to control general operation of the electronic device 400.

The processor 450 is configured to recognize a command from the user input based on receiving of the user input from the input device 410, and control an operation of the audio device based on the recognized command.

The processor 450 is configured to power on or off based on a user input.

The processor 450 is configured to control audio play, audio stop, volume up or volume down based on a user input.

The processor 450 is also configured to control mode switching between an audio mode and a call mode based on a user input.

The processor 450 is also configured to receive the user input received by the external device 500 through the communicator 420.

The processor 450 is configured to recognize a target sound image location of the user based on acceleration information detected by the acceleration sensor and angular velocity information detected by the gyro sensor of the sensing device 430.

The processor 450 is configured to recognize a target azimuth angle and a target elevation angle of the head in recognizing the target sound image location of the user.

The processor 450 is configured to generate a sound image having a stereoscopic effect and a spatial effect by filtering the input source received through the communicator 420 with the transfer function data, and control the speaker 440 to output the generated sound image.

The input source may be an input audio signal that is subject to binaural rendering.

The sound image may be an output audio signal. The output audio signal may be a binaural audio signal. For example, the output audio signal may be a two-channel audio signal in which an input audio signal is represented by a virtual sound source located in 3D space.

The processor 450 is configured to recognize whether there is a reference sound image location equal to the target sound image location among the plurality of reference sound image locations stored in the memory 460, recognize a reference transfer function corresponding to the recognized reference sound image location based on the recognizing of the presence of the reference sound image location equal to the target sound image location, and create a sound image by filtering the recognized reference transfer function and the input source.

Based on recognizing of the absence of any reference sound image location equal to the target sound image location not being recognized, the processor 450 is configured to create a transfer function corresponding to the target sound image location based on the input source, the target sound image location, the plurality of reference sound image locations, the pre-stored reference transfer functions and the pre-stored initial delays, create a sound image having stereo and spatial effects by filtering the created transfer function, and control the communicator 440 to output the created sound image through the speaker 440.

Based on recognizing of the absence of any reference sound image location equal to the target sound image location, the processor 450 is configured to determine first and second indexes based on the target sound image location and the plurality of reference sound image locations in creating a transfer function corresponding to the target sound image location, obtain first and second weights based on the determined first and second indexes, create a target transfer function based on the first and second initial delays and the first and second reference transfer functions corresponding to the first and second indexes, create a sound image based on the created target transfer function and the input source, and control output of the created sound image.

The processor 450 is configured to determine first and second azimuth indexes and first and second elevation indexes based on the target sound image location and the plurality of reference sound image locations, obtain first and second weights based on the determined first and second azimuth indexes, obtain third and fourth weights based on the determined first and second elevation indexes, and obtain first, second, third and fourth initial delays and first, second, third and fourth reference transfer functions corresponding to the first, second, third and fourth indexes.

The processor 450 is configured to obtain a first magnitude based on the first and second indexes and the first and second reference transfer functions, and obtain a second magnitude based on the first and second elevation indexes and the third and fourth reference transfer functions. The first magnitude is a magnitude obtained for creating a first interpolation transfer function, and the second magnitude is a magnitude obtained for creating a second interpolation transfer function.

The processor 450 is configured to create the first interpolation transfer function based on the first and second weights, the first and second azimuth indexes, the first and second reference transfer functions and the first magnitude, and create the second interpolation transfer function based on the third and fourth weights, the first and second elevation indexes, the third and fourth reference transfer functions and the second magnitude.

The processor 450 is configured to obtain first and second initial delays corresponding to the first and second azimuth indexes and third and fourth initial delays corresponding to the first and second elevation indexes based on the information stored in the memory 460, obtain a first adjusted delay based on the first and second weights, the first interpolation transfer function and the first and second initial delays, and obtain a second adjusted delay based on the third and fourth weights, the second interpolation transfer function and the third and fourth initial delays.

The processor 450 may create a third interpolation transfer function based on the first and second interpolation transfer functions, and obtain a third adjusted delay based on the first and second adjusted delays.

The processor 450 may create a target transfer function based on the third interpolation transfer function and the third adjusted delay.

A detailed configuration of the processor 450 is the same as in FIG. 5, so the description will not be repeated.

The processor 450 may use data stored in the memory 460 to perform the aforementioned operation.

The processor 450 may include hardware such as a CPU, a memory, etc., and software such as a control program. For example, the processor 150 may include at least one memory for storing data in the form of a program and an algorithm for controlling operations of components in the audio device, and one or more processor chips or one or more processing cores for performing the aforementioned operations by using the data stored in the at least one memory.

The processor 450 may include an extra NPU for performing operation of an AI model.

The memory 460 may store a plurality of pieces of reference sound image location information corresponding to the plurality of reference sound image locations, a plurality of pieces of reference transfer function information corresponding to the plurality of reference sound image locations, and a plurality of pieces of initial delay information corresponding to the plurality of reference sound image locations.

The reference transfer function information is information that may be obtained by taking a fast Fourier transform (FFT) on a head related impulse response (HRIR) signal. Specifically, the reference transfer function information may be obtained by analyzing and modifying the HRIR signal in terms of frequency.

The reference transfer function information includes information about transfer functions for left and right ears when an input source is output at each of the plurality of reference sound image locations.

The memory 460 and the processor 140 may be implemented in separate chips. Alternatively, the memory 460 and the processor 450 may be implemented in a single chip.

The memory 460 may store an algorithm for controlling operations of the components in the electronic device 400 or data for a program that represents the algorithm.

The memory 460 may be implemented with a non-volatile memory device such as cache, read only memory (ROM), programmable ROM (PROM), erasable programmable ROM (EPROM), electrically erasable programmable ROM (EEPROM) and flash memory, or a volatile memory device such as random access memory (RAM) and dynamic RAM (DRAM), without being limited thereto.

The electronic device 400 includes at least one of a microphone 470, a display 480 and a power module 490.

The microphone 470 is configured to receive voice of the user and transmit the received voice to the processor 450. There may be one or more microphones 470. In this case, the processor 450 is configured to transmit the received voice to the external device 500 through the communicator 420.

Two or more microphones may be for beamforming.

The display 480 is configured to display information corresponding to an operation state of the electronic device 400 in response to a control command of the processor 450.

For example, the display 480 may display a power-on state, a power-off state, an audio output state, an audio stop state, a battery low state, a call state, etc., of the audio device.

The display 480 may include a digital light processing (DLP) panel, a plasma display panel (PDP), a liquid crystal display (LCD) panel, an electro luminescence (EL) panel, an electrophoretic display (EPD) panel, an electrochromic display (ECD) panel, a light emitting diode (LED) panel, an organic light emitting diode (OLED) panel, etc., but is not limited thereto.

The power module 490 is configured to supply power to the respective components of the electronic device 400.

The power module 490 may include a rechargeable battery.

At least one component may be added to or omitted from the electronic device to correspond to the performance of the electronic device as shown in FIGS. 9 and 10. Furthermore, it will be obvious to those of ordinary skill in the art that the relative positions of the components may be changed to correspond to the system performance or structure.

The components shown in FIGS. 9 and 10 may refer to software, or hardware components such as Field Programmable Gate Arrays (FPGAs) and Application Specific Integrated Circuits (ASICs).

Meanwhile, the embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be a ROM, a RAM, a magnetic tape, a magnetic disk, a flash memory, an optical data storage device, etc.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

What is claimed is:

1. An electronic device comprising:
a memory storing information about a plurality of reference sound image locations, a plurality of reference transfer functions corresponding to the plurality of reference sound image locations, respectively, and initial delays;
a communicator configured to receive detection information about a motion of a head; and
a processor configured to recognize a target sound image location based on the detection information about the motion of the head received by the communicator, determine some of the plurality of reference sound image locations as a plurality of indexes based on the recognized target sound image location, obtain initial delays and reference transfer functions corresponding to the determined plurality of indexes determined based on the information stored in the memory, obtain a weight for each index based on the determined plurality of indexes, and create a target transfer function based on the obtained weight for each index, the obtained reference transfer functions and the obtained initial delays.

2. The electronic device of claim 1, wherein:
the plurality of indexes comprise a first index and a second index,
the obtained reference transfer functions comprise a first reference transfer function corresponding to the first index and a second reference transfer function corresponding to the second index, and
the processor is configured to obtain a first weight for the first index and a second weight for the second index based on the first and second indexes, obtain a magnitude based on the first reference transfer function, the second reference transfer function and the first and second weights, and create an interpolation transfer function based on one of the first and second reference transfer functions and the obtained magnitude.

3. The electronic device of claim 2, wherein the processor is configured to:
identify the larger of the first and second weights, obtain an index corresponding to the identified weight, obtain a phase of one of the first and second reference transfer functions, which corresponds to the obtained index, as a reference phase for creating the interpolation transfer function, and
create the interpolation transfer function based on the magnitude and the phase of the reference transfer function corresponding to the obtained index among the first and second reference transfer functions.

4. The electronic device of claim 2, wherein:
the obtained initial delays comprise a first initial delay corresponding to the first index and a second initial delay corresponding to the second index, and
the processor is configured to obtain an adjusted delay based on the first and second weights and the first and second initial delays, and create the target transfer function based on the obtained adjusted delay and the created interpolation transfer function.

5. The electronic device of claim 1, wherein the processor is configured to obtain a coordinate value of the recognized target sound image location and a coordinate value of each of the plurality of reference sound image locations, obtain a distance between the obtained coordinate value of the recognized target sound image location and the coordinate value of each of the plurality of reference sound image locations, and obtain a weight for each of the indexes based on the obtained each distance.

6. The electronic device of claim 1, further comprising:
a sensing device configured to detect a motion of the head and transmit information about the detecting to the processor through the communicator; and
a speaker,
wherein the communicator is configured to communicate with an external device, and
wherein the processor is configured to create a sound image based on an input source received from the external device and the created target transfer function, and control the speaker to output the created sound image through the speaker.

7. The electronic device of claim 1, wherein:
the communicator is configured to communicate with an external device and an audio output device, and
the processor is configured to create a sound image based on an input source received from the external device and the created target transfer function, and transmit the created sound image to the audio output device.

8. The electronic device of claim 1, wherein:
the target sound image location comprises a target azimuth angle and a target elevation angle, and
each of the plurality of reference sound image locations comprises a reference azimuth angle and a reference elevation angle.

9. The electronic device of claim 1, wherein the processor is configured to determine a preset number of reference azimuth angles in a sequence of having a smaller difference in azimuth from the target azimuth angle among a plurality of reference azimuth angles, determine a preset number of reference elevation angles in a sequence of having a smaller difference in elevation from the target elevation angle among a plurality of reference elevation angles, and determine a plurality of indexes based on the determined preset number of reference azimuth angles and the determined preset number of reference elevation angles.

10. The electronic device of claim 1, wherein the processor is configured to create a sound image based on a reference transfer function corresponding to a reference sound image location equal to the target sound image location based on the presence of the reference sound image location equal to the target sound image location among the plurality of reference sound image locations.

11. A method of controlling an electronic device, the method comprising:
recognizing a target sound image location based on detection information about a motion of a head,
determining some of a plurality of reference sound image locations stored in a memory as a plurality of indexes based on the recognized target sound image location,
obtain initial delays and reference transfer functions corresponding to the determined plurality of indexes determined based on the information stored in the memory,
obtain a weight for each index based on the determined plurality of indexes,
create a target transfer function based on the obtained weight for each index, the obtained reference transfer functions and the obtained initial delays,
create a sound image based on an input source received from an external device and the created target transfer function, and
control output of the created sound image.

12. The method of claim 11, wherein:
the plurality of indexes comprise a first index and a second index,
the obtained reference transfer functions comprise a first reference transfer function corresponding to the first index and a second reference transfer function corresponding to the second index, and
the creating of the interpolation transfer function comprises obtaining a first weight for the first index and a second weight for the second index based on the first and second indexes, obtaining a magnitude based on the first reference transfer function, the second reference transfer function and the first and second weights, and creating an interpolation transfer function based on a phase of one of the first and second reference transfer functions and the obtained magnitude.

13. The method of claim 12, further comprising:
identifying the larger of the first and second weights,
obtaining an index corresponding to the identified weight, and
obtaining a phase of a reference transfer function corresponding to the obtained index among the first and second reference transfer functions as a reference phase of the interpolation transfer function,
wherein the creating of the interpolation transfer function comprises creating the interpolation transfer function based on the magnitude and a phase of a reference transfer function corresponding to the obtained index among the first and second reference transfer functions.

14. The method of claim 11, wherein:
the obtained initial delays comprise a first initial delay corresponding to the first index and a second initial delay corresponding to the second index,
the creating of the target transfer function comprises obtaining an adjusted delay based on the first and second weights and the first and second initial delays, and creating the target transfer function based on the obtained adjusted delay and the created interpolation transfer function, and
the obtaining of the weight for each index comprises obtaining a coordinate value of the recognized target sound image location and a coordinate value of each of the plurality of reference sound image locations, obtaining a distance between the obtained coordinate value of the recognized target sound image location and the coordinate value of each of the plurality of reference sound image locations, and obtaining a weight for each of the indexes based on the obtained each distance.

15. The method of claim 11, wherein:
the target sound image location comprises a target azimuth angle and a target elevation angle,
each of the plurality of reference sound image locations comprises a reference azimuth angle and a reference elevation angle, and
the determining of the plurality of indexes comprises determining a preset number of reference azimuth angles in a sequence of having a smaller difference in azimuth from the target azimuth angle among a plurality of reference azimuth angles, determining a preset number of reference elevation angles in a sequence of having a smaller difference in elevation from the target elevation angle among a plurality of reference elevation angles, and determining a plurality of indexes based on the determined preset number of reference azimuth angles and the determined preset number of reference elevation,
further comprising: creating the target transfer function based on a reference sound image location equal to the target sound image location not being present among the plurality of reference sound image locations.
